(19) United States
(12) Patent Application Publication
(10) Pub. No.: US 2021/0097548 A1
(43) Pub. Date: Apr. 1, 2021

(54) METHOD AND SYSTEM FOR CLOSED LOOP PAYMENT PROCESSING

(71) Applicant: PlutoCard Inc., New York, NY (US)

(72) Inventors: Richard Reza SOLOMON, Stamford, CT (US); Mohsen CHITSAZ, Weehawken, NJ (US)

(21) Appl. No.: 16/703,361

(22) Filed: Dec. 4, 2019

Related U.S. Application Data
(60) Provisional application No. 62/908,592, filed on Sep. 30, 2019.

(51) Int. Cl. G06Q 20/40; G06Q 20/34; G06Q 20/20

(52) U.S. Cl. CPC G06Q 20/40145; G06Q 20/4014; G06Q 20/20; G06Q 20/34

(57) ABSTRACT

There is provided a method for closed loop payment processing. The method includes (a) receiving, from a first device, a communication indicating that a customer desires to make a purchase, (b) sending, to a second device, a request for the customer to provide an authorization for the purchase, and (c) receiving, from the second device, a response that confirms the authorization. There is also provided a system that performs the method, and a storage device that contains instructions that cause a processor to perform the method.

### BACKGROUND OF THE DISCLOSURE

### 1. Field of the Disclosure

The present disclosure relates to a commercial transaction, and more particularly, to a commercial transaction that employs a payment card, such as a credit card or a debit card.

### 2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

There is a market for stolen credit card data.

Conventional credit card systems held transactions in a pending state for a pending period. The pending period was designed for reasons such as (a) to allow for post-transaction adjustments to payments, for example, adding a tip, gas station, hotel, car rental, and (b) to obtain authorization for a transaction, for example, where a merchant obtains a cardholder's signature and send it to an issuer bank.

In systems using traditional credit cards, a hacker can steal a cardholder's data by intercepting a pending transaction at a point of sale (POS) terminal or by an online breach. Thus, data can be stolen at POS, and used during the pending period.

EMV (i.e., Europay, Mastercard and Visa) employs chip-based cards which reduce the opportunity for making counterfeit cards. However, EMV is not readily usable for online transactions. Moreover, a stolen credit card, even if it employs EMV, can be used when physically presented to a merchant.

### SUMMARY OF THE DISCLOSURE

An object of the present disclosure is to enable a customer to engage in a commercial transaction, e.g., to make a purchase, and provide an authorization for the transaction in a manner that minimizes an opportunity for fraud.

To achieve this objective, there is provided a method that includes (a) receiving, from a first device, a communication indicating that a customer desires to make a purchase, (b) sending, to a second device, a request for the customer to provide an authorization for the purchase, and (c) receiving, from the second device, a response that confirms the authorization. There is also provided a system that performs the method, and a storage device that contains instructions that cause a processor to perform the method.

### BRIEF DESCRIPTION OF THE DRAWINGS

FIG. 1 is a block diagram of a system for processing of a payment in a commercial transaction.

FIG. 2 is block diagram of an exemplary transaction being conducted via the system of FIG. 1.

FIGS. 3A-3C are, collectively, a flowchart of a method for processing of a payment in a commercial transaction in the system of FIG. 1.

FIG. 4 is a table that lists several problems, and for each problem, briefly describes (a) how other credit cards have addressed the problem, and (b) how the system of FIG. 1 addresses the problem.

A component or a feature that is common to more than one drawing is indicated with the same reference number in each of the drawings.

### DESCRIPTION OF THE DISCLOSURE

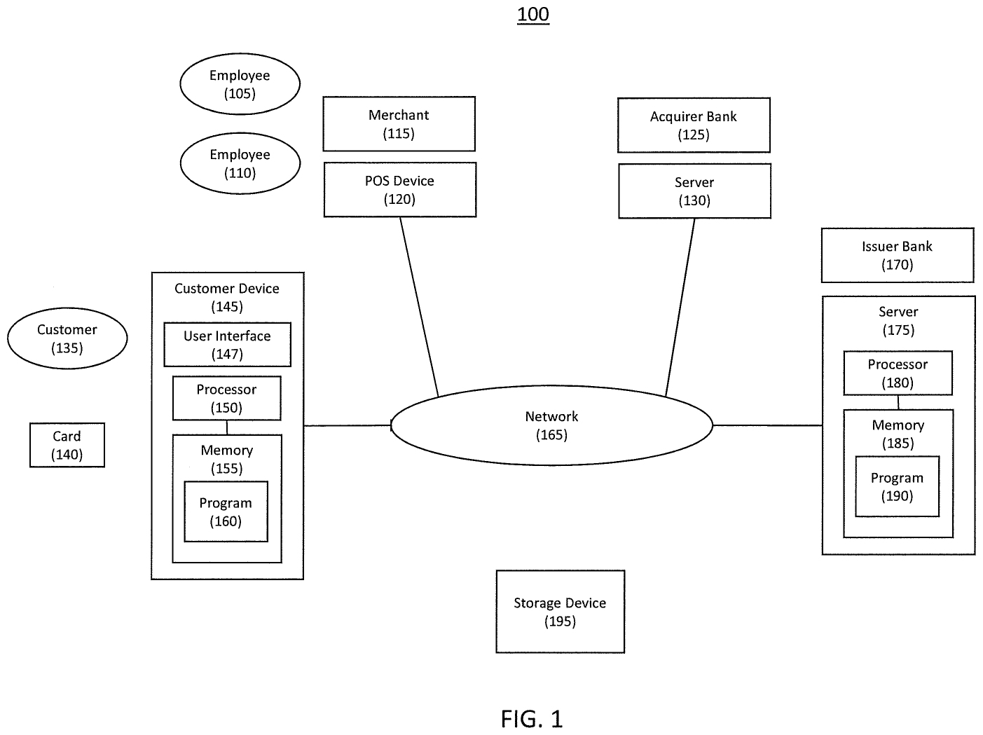

FIG. 1 is a block diagram of a system, namely system 100, for processing of a payment in a commercial transaction. A customer 135 wishes to obtain a product or a service from a merchant 115, and pay for the product or service by utilization of a payment card, namely card 140. Other parties involved the transaction include an acquirer bank 125 and an issuer bank 170. Acquirer bank 125 is a bank that processes the transaction on behalf of merchant 115. Issuer bank 170 is a bank, or other financial institution, that issued card 140 to customer 135. Merchant 115 employs employees 105 and 110 who may also play a role in the transaction.

To facilitate the transaction, customer 135 uses a customer device 145, merchant 115 uses a point of sale (POS) device 120, acquirer bank 125 uses a server, namely an acquirer bank server 130, and issuer bank 170 uses a server, namely issuer bank server 175. Customer device 145, POS device 120, acquirer bank server 130, and issuer bank server 175 are communicatively coupled to a network 165.

Network 165 is a data communications network. Network 165 may be a private network or a public network, and may include any or all of (a) a personal area network, e.g., covering a room, (b) a local area network, e.g., covering a building, (c) a campus area network, e.g., covering a campus, (d) a metropolitan area network, e.g., covering a city, (e) a wide area network, e.g., covering an area that links across metropolitan, regional, or national boundaries, (0 the Internet, or (g) a telephone network. Communications are conducted via network 165 by way of electronic signals and optical signals that propagate through a wire or optical fiber, or are transmitted and received wirelessly.

Customer device 145 includes a user interface 147, a processor 150, and a memory 155. User interface 147 and memory 155 are operationally coupled to processor 150.

User interface 147 includes an input device, such as a keyboard, speech recognition subsystem, a camera and a gesture recognition subsystem, for enabling customer 135 to communicate information to and from processor 150, and via network 165, to and from issuer bank server 175. User interface 147 also includes an output device such as a display, and a speech synthesizer and a speaker. A cursor control or a touch-sensitive screen allows customer 135 to utilize user interface 147 for communicating additional information and command selections to processor 150 and issuer bank server 175.

Processor 150 is an electronic device configured of logic circuitry that responds to and executes instructions.

Memory 155 is a tangible, non-transitory, computer-readable storage device encoded with a computer program. In this regard, memory 155 stores data and instructions, i.e., program code, that are readable and executable by processor 150 for controlling the operation of processor 150. Memory 155 may be implemented in a random access memory (RAM), a hard drive, a read only memory (ROM), or a combination thereof. One of the components of memory 155 is a program module, namely program 160, which contains instructions for controlling processor 150 to perform operations in accordance with the methods described herein.

The term “module” is used herein to denote a functional operation that may be embodied either as a stand-alone component or as an integrated configuration of a plurality of subordinate components. Thus, program 160 may be implemented as a single module or as a plurality of modules that operate in cooperation with one another. Moreover, although program 160 is described herein as being installed in memory 155, and therefore being implemented in software, it could be implemented in any of hardware (e.g., electronic circuitry), firmware, software, or a combination thereof

An exemplary embodiment of customer device 145 is a smartphone or other mobile device.

Card 140 can be a conventional, physical card, or a virtual representation of a card, such as in a digital wallet on customer device 145.

POS device 120 includes a reader for reading information from card 140, and circuitry for engaging in data communication via network 165.

Acquirer bank server 130 includes a computer for processing a commercial transaction as described herein, and circuitry for engaging in data communication via network 165.

Issuer bank server 175 includes a processor 180, and a memory 185 that is operationally coupled to processor 180.

Processor 180 is an electronic device configured of logic circuitry that responds to and executes instructions.

Memory 185 is a tangible, non-transitory, computer-readable storage device encoded with a computer program. In this regard, memory 185 stores data and instructions, i.e., program code, that are readable and executable by processor 180 for controlling the operation of processor 180. Memory 185 may be implemented in a random access memory (RAM), a hard drive, a read only memory (ROM), or a combination thereof. One of the components of memory 185 is a program module, namely program 190, which contains instructions for controlling processor 180 to perform operations in accordance with the methods described herein.

Program 190 may be implemented as a single module or as a plurality of modules that operate in cooperation with one another. Moreover, although program 190 is described herein as being installed in memory 185, and therefore being implemented in software, it could be implemented in any of hardware (e.g., electronic circuitry), firmware, software, or a combination thereof

While programs 160 and 190 are indicated as being already loaded into memories 155 and 185, respectively, either or both of programs 160 and 190 may be configured on a storage device 195 for subsequent loading into memories 155 and 185. Storage device 195 is a tangible, non-transitory, computer-readable storage device that stores programs 160 and 190 thereon. Examples of storage device 195 include (a) a compact disk, (b) a magnetic tape, (c) a read only memory, (d) an optical storage medium, (e) a hard drive, (0 a memory unit consisting of multiple parallel hard drives, (g) a universal serial bus (USB) flash drive, (h) a random access memory, and (i) an electronic storage device coupled to customer device 145 and issuer bank server 175 via network 165.

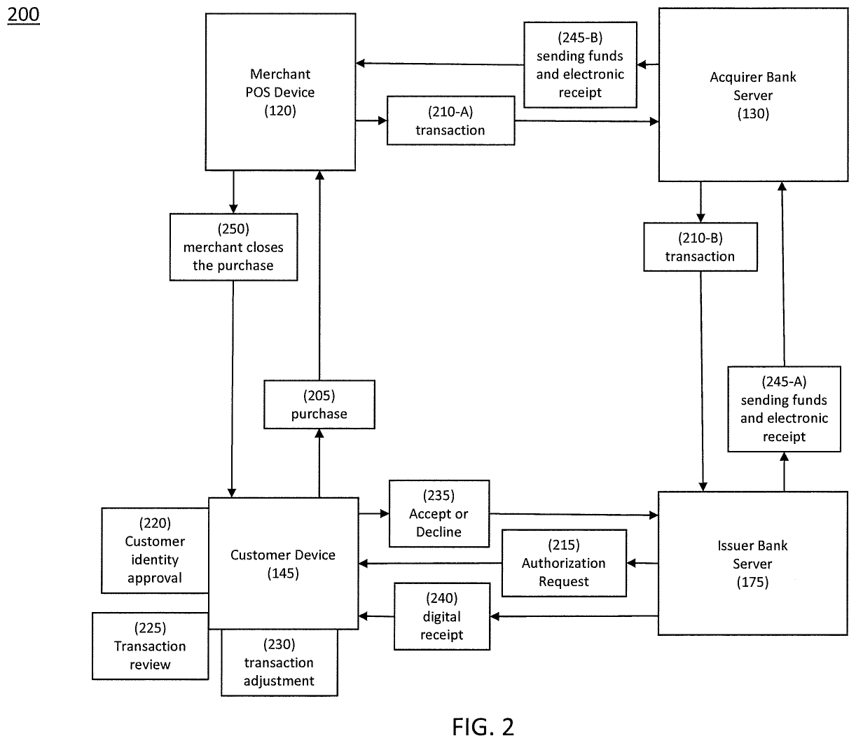

FIG. 2 is block diagram of an exemplary transaction, namely transaction 200, being conducted via system 100.

In operation 205, customer 135 initiates a purchase of goods or serves from merchant 115, and accordingly presents card 140 to POS device 120, which reads information from card 140. The information that POS device 120 reads from card 140 includes the cardholder's name, the 16-digit card number, the expiration date, and a security code associated with card 140. POS device 120 further has the option to encrypt the information read from card 140 and package the information ready for transmission.

In operation 210-A, soon after customer 135 presents card 140 to POS device 120, POS device 120 transmits a transaction request to acquirer bank server 130.

In operation 210-B, acquirer bank server 130 processes the transaction request on behalf of acquirer bank 125, and forwards a corresponding transaction request to issuer bank server 175. In practice, in addition to operations being performed by or on behalf of acquirer bank 125, processing may involve operations being perform by or on behalf of other credit card issuing entities in a transaction gateway (not shown). A transaction gateway is also referred to as a payment gateway.

In operation 215, issuer bank server 175, in response to its receipt of the transaction request from acquirer bank server 130, sends an authorization request to customer device 145 via network 165.

In operation 220, customer device 145 receives the authorization request, and in response, presents a transaction authorization notification to customer 135 on user interface 147. In one embodiment, customer 135 interacts with the transaction authorization on customer device 145, without having to unlock customer device 145. In a preferred embodiment, customer 135 unlocks customer device 145, for example by using an identifier such as a passcode, a face ID, a touch ID, a fingerprint ID, or voice recognition, where the identifier is registered as customer 135's signature. In practice, the manner in which customer device 145 is unlocked may depend on a requirement of customer device 145. Thus, customer 135's unlocking of customer device 145 by use of the identifier ensures that customer device 145 is being used by customer 135.

In operation 225, customer 135 is able to review the accuracy of transaction details, such as the purchase amount, and the name and location of merchant 115.

In operation 230, customer 135 is given an opportunity to apply a post-transaction adjustment. For example, customer 135 may provide a tip to either or both of employees 105 and 110.

In operation 235, customer 135 may either authorize the transaction or decline the transaction, for example, by selecting an appropriate button on the authorization request as it is presented on user interface 147. Accordingly, customer device 145 sends via network 165, to issuer bank server 175, a response to “accept” or “decline”, or “authorize” or “not authorize”. The response can include any suitable phrase or symbol that indicates customer 135's desire to authorize or decline the transaction.

In operation 240, upon receipt of the response, i.e., accept or decline, issuer bank server 175 sends a digital receipt to customer device 145.

In operation 245-A, issuer bank server 175, after receiving the response from customer device 145 indicating that customer 135 has authorized the transaction, transmits a communication to acquirer bank server 130 that includes an electronic receipt and indicates that corresponding funds are being sent from issuer bank 170 to acquirer bank 125 as an approval and settlement of the transaction. In practice, and as mentioned above, in addition to operations being performed by or on behalf of acquirer bank 125, processing may involve operations being perform by or on behalf of other credit card issuing entities in a transaction gateway.

In operation 245-B, acquirer bank server 130 transmits a communication to POS device 120 that includes an electronic receipt and indicates that corresponding funds are being credited to merchant 115's account as an approval and settlement of the transaction.

In operation 250, merchant 115, upon POS device 120 receiving the communication indicating the approval and settlement of the transaction, provides the goods or services to customer 135. Thus, the transaction is approved, settled and closed.

Thus, in issuer bank server 175, processor 180 executes a method that includes (a) receiving, from a first device, e.g., acquirer bank server 130, a communication indicating that a customer, e.g., customer 135, desires to make a purchase, (b) sending, to a second device, e.g., customer device 145, a request for the customer to provide an authorization for the purchase, and (c) receiving, from the second device, a response that confirms the authorization. There is also provided a system, e.g., issuer bank server 175, that performs the method, and a storage device, e.g., storage device 195, that contains instructions that cause a processor to perform the method.

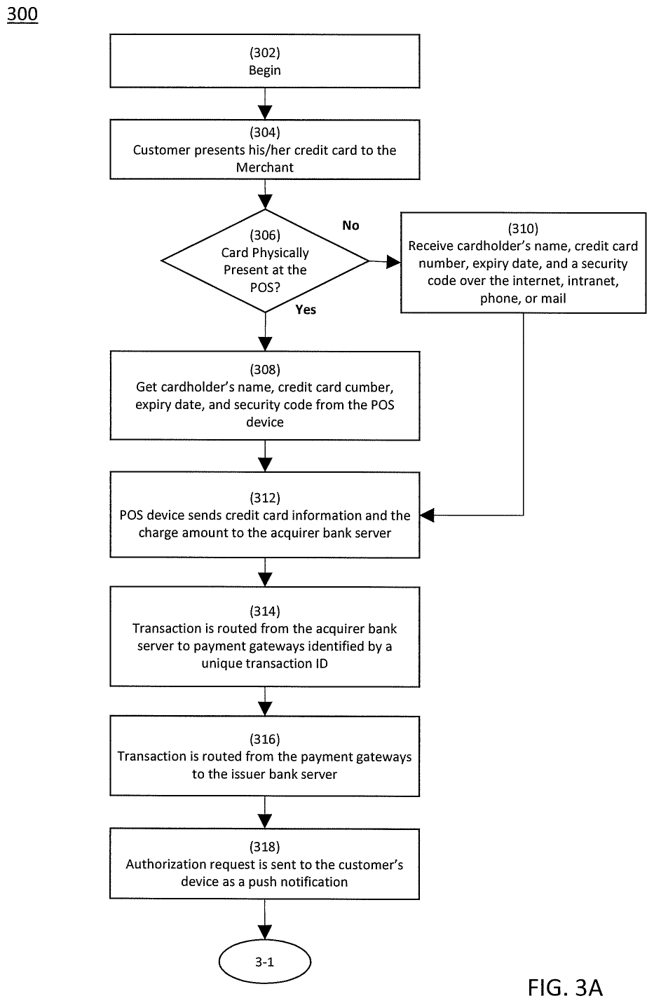

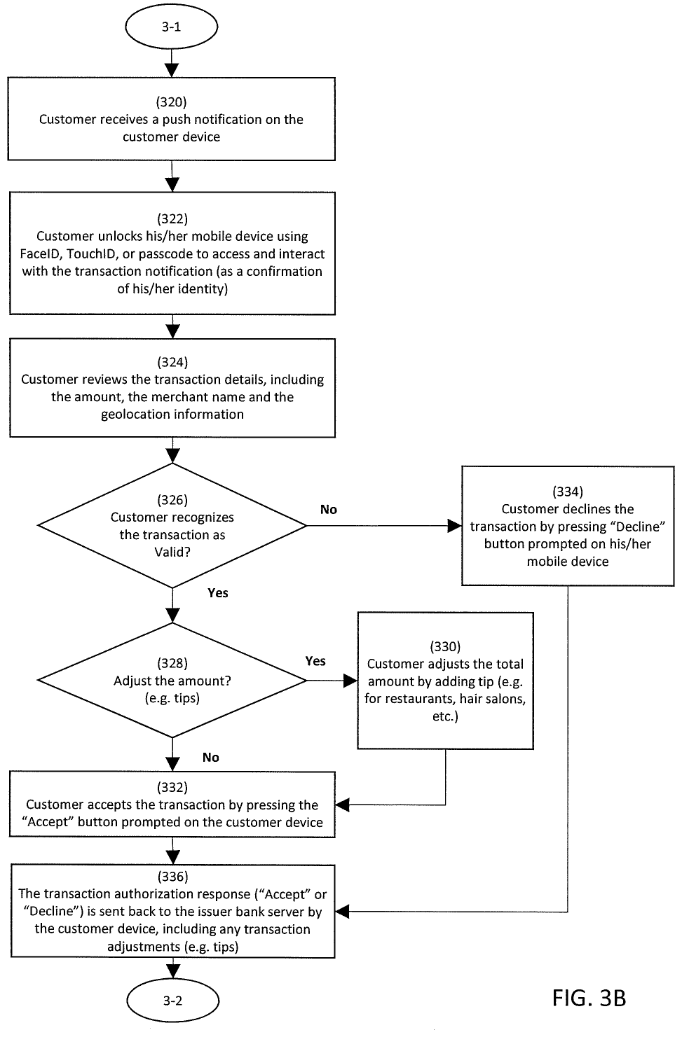

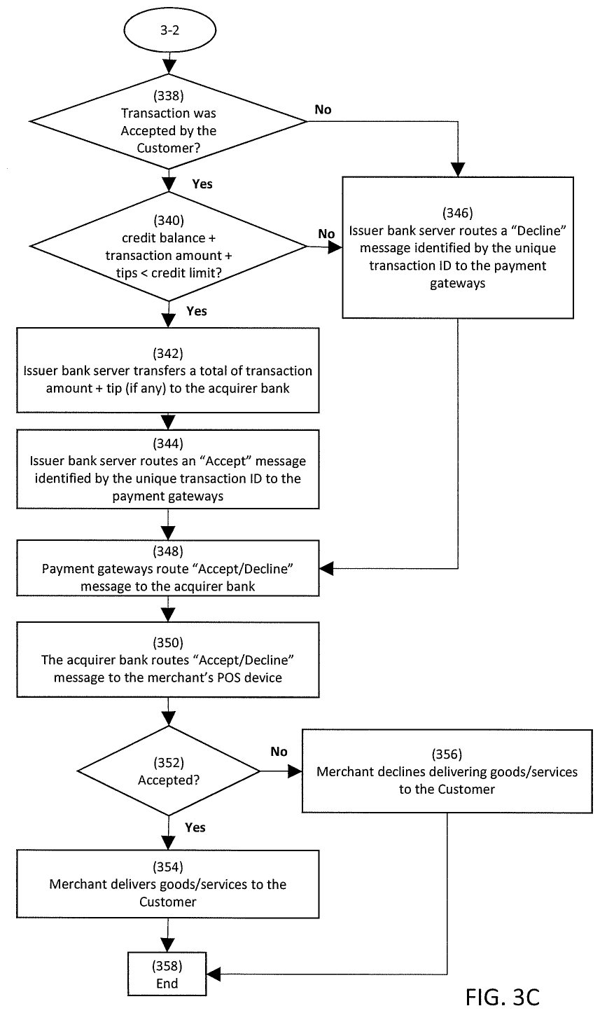

FIGS. 3A-3C are, collectively, a flowchart of a method 300 for processing of a payment in a commercial transaction in system 100. Flowchart lines are bridged to one by way of connecting bubbles, e.g., bubble 3-1 provides a bridge from FIG. 3A to FIG. 3B.

In operation 302, method 300 begins.

In operation 304, customer 135 presents card 140 to merchant 115. Operation 304 can be performed either online on a website, by phone or by mail, where the information of card 140 are presented to POS device 120 digitally without the presence of the physical card 140, or it is performed physically by swiping, inserting or tapping card 140 at POS device 120.

In operation 306, merchant 115 determines whether card 140 is physically present at POS device 120. If card 140 is physically present, method 300 progresses to operation 308. If card 140 is not physically present, method 300 advances to operation 310.

In operation 308, POS device 120 reads card 140 to obtain a cardholder's name, a credit card number, an expiry date, and a security code. From operation 308, method 300 advances to operation 312.

In operation 310, POS device 120 receives the cardholder's name, credit card number, expiry date and security code of card 140 digitally over the internet, intranet, phone or mail from customer 135.

In operation 312, POS device 120 sends credit card information and the charge amount to acquirer bank server 130.

In operation 314, acquirer bank server 130 routes, to payment gateways, a transaction identified by a unique transaction ID.

In operation 316, the transaction is routed from the payment gateways to issuer bank server 175.

In operation 318, issuer bank server 175 sends an authorization request to customer device 145, as a push notification. From operation 318, method 300 progresses to operation 320.

In operation 320, customer 135 receives the push notification on customer device 145.

In operation 322, customer 135 unlocks customer device 145 using, face ID, touch ID, fingerprint ID, a passcode, or voice recognition, to access and interact with the transaction notification (as a confirmation of his/her identity).

In operation 324, on customer device 145, customer 135 reviews transaction details, including the amount, the merchant name, and geolocation information.

In operation 326, customer 135 considers whether the transaction is valid. if the transaction is valid, method 300 progresses to operation 328. If the transaction is not valid, method 300 advances to operation 334.

In operation 328, customer 135 considers whether to adjust the amount of the payment, e.g., to provide a tip to one or both of employees 105 and 110. If customer 135 wishes to adjust the amount, method 300 progresses to operation 330. If customer 135 does not wish to adjust the amount, method 300 advances to operation 332.

In operation 330, customer 135 adjusts the total amount, e.g., by adding a tip.

In operation 332, customer 135 accepts the transaction, e.g., by pressing an “Accept” button prompted on customer device 145. From operation 332, method 300 advances to operation 336.

In operation 334, customer 135 declines the transaction, e.g., by pressing a “Decline” button prompted on customer device 145.

In operation 336, customer device 145 sends a transaction authorization response (“Accept” or “Decline”) to issuer bank server 175, including any transaction adjustments, e.g., tips. From operation 336, method 300 progresses to operation 338.

In operation 338, issuer bank server 175 considers whether the transaction was accepted by customer 135. If the transaction was accepted, method 300 progresses to operation 340. If the transaction was not accepted, method 300 advances to operation 346.

In operation 340, issuer bank server 175 considers whether the sum of (a) customer 135's credit, (b) the transaction amount, and (c) adjustments (if any), is less than customer 135's credit limit. If the sum is less than the credit limit, method 300 progresses to operation 342. If the sum is not less than the credit limit, i.e., if the sum exceeds the credit limit, method 300 advances to operation 346.

In operation 342, issuer bank server 175 transfers a total of transaction amount, plus adjustment (if any) to acquirer bank 125.

In operation 344, issuer bank server 175 routes an “Accept” message identified by the unique transaction number (see operation 314) to the payment gateways. From operation 344, method 300 advances to operation 348.

In operation 346, issuer bank server 175 routes a “Decline” message identified by the unique transaction ID (see operation 314) to the payment gateways.

In operation 348, the payment gateways route the payment gateways route an “Accept/Decline” message to acquirer bank server 130.

In operation 350, acquirer bank server 130 routes the “Accept/Decline” message to POS device 120.

In operation 352, merchant 115 considers whether customer 135 accepted the transaction. If the transaction was accepted, method 300 progresses to operation 354. If the transaction was not accepted, method 300 advance to operation 356.

In operation 354, merchant 115 delivers goods/services to customer 135. From operation 354, method 300 advances to operation 358.

In operation 356, merchant 115 declines delivering goods/services to customer 135.

In operation 358, method 300 ends.

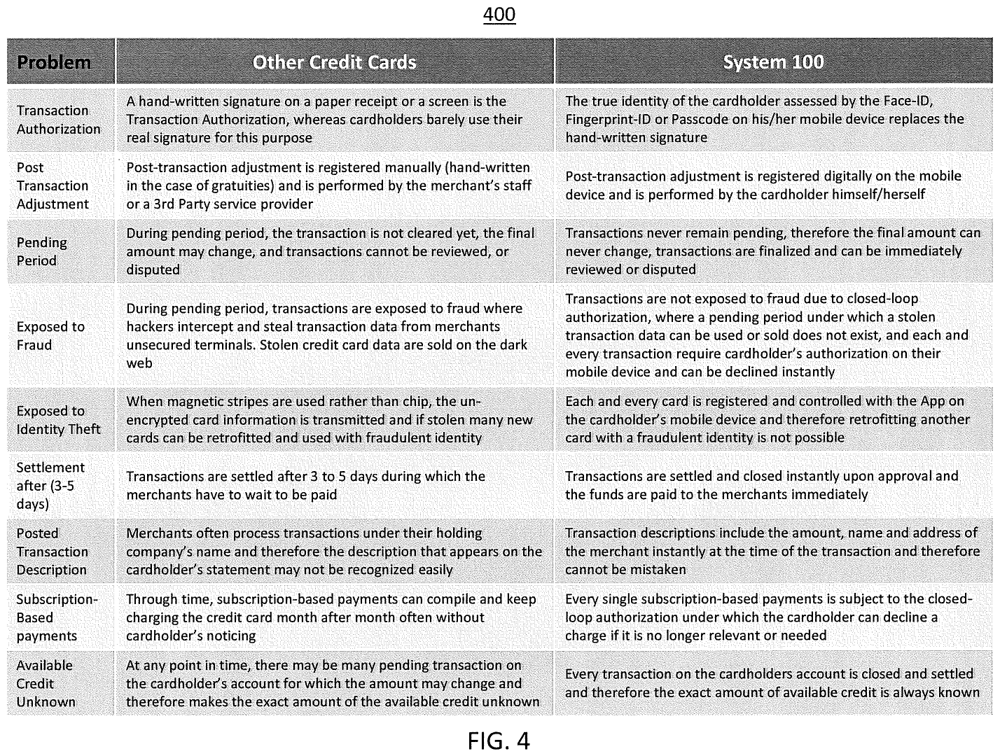

FIG. 4 is a table 400 that lists several problems, and for each problem, briefly describes (a) how other credit cards have addressed the problem, and (b) how system 100 addresses the problem.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

What is claimed is:

1. A method comprising:
receiving, from a first device, a communication indicating that a customer desires to make a purchase;
sending, to a second device, a request for said customer to provide an authorization for said purchase; and
receiving, from said second device, a response that confirms said authorization.

2. The method of claim 1, wherein said customer, in order to provide said authorization, must log into said second device by way of a unique identifier.

3. The method of claim 2, wherein said unique identifier is selected from the group consisting of a passcode, a touch ID, a fingerprint ID, a face ID, and voice recognition.

4. The method of claim 1, wherein said request includes information selected from the group consisting of an amount of said purchase, a name of a merchant from which said purchase is being made, and a location of said merchant.

5. The method of claim 1, wherein said response further includes an adjustment to an amount of said purchase.

6. The method of claim 1, wherein said second device is a mobile device of said customer.

7. A system comprising:
a processor; and
a memory that contains instructions that are readable by said processor to cause said processor to perform operations of:
receiving, from a first device, a communication indicating that a customer desires to make a purchase;
sending, to a second device, a request for said customer to provide an authorization for said purchase; and
receiving, from said second device, a response that confirms said authorization.

8. The system of claim 7, wherein said customer, in order to provide said authorization, must log into said second device by way of a unique identifier.

9. The system of claim 8, wherein said unique identifier is selected from the group consisting of a passcode, a touch ID, a fingerprint ID, a face ID, and voice recognition.

10. The system of claim 7, wherein said request includes information selected from the group consisting of an amount of said purchase, a name of a merchant from which said purchase is being made, and a location of said merchant.

11. The system of claim 7, wherein said response further includes an adjustment to an amount of said purchase.

12. The system of claim 7, wherein said second device is a mobile device of said customer.

13. A storage device that is non-transitory, comprising instructions that are readable by a processor to cause said processor to perform operations of:
receiving, from a first device, a communication indicating that a customer desires to make a purchase;
sending, to a second device, a request for said customer to provide an authorization for said purchase; and
receiving, from said second device, a response that confirms said authorization.

14. The storage device of claim 13, wherein said customer, in order to provide said authorization, must log into said second device by way of a unique identifier.

15. The storage device of claim 14, wherein said unique identifier is selected from the group consisting of a passcode, a touch ID, a fingerprint ID, a face ID, and voice recognition.

16. The storage device of claim 13, wherein said request includes information selected from the group consisting of an amount of said purchase, a name of a merchant from which said purchase is being made, and a location of said merchant.

17. The storage device of claim 13, wherein said response further includes an adjustment to an amount of said purchase.

18. The storage device of claim 13, wherein said second device is a mobile device of said customer.
